(19) United States
(12) Patent Application Publication
(10) Pub. No.: US 2002/0148909 A1
(43) Pub. Date: Oct. 17, 2002

(54) Cooling device using fan-driven misting with large bottom fill port

(76) Inventors: Eric F. Junkel, Des Plaines, IL (US); Linda M. Usher, Chicago, IL (US); Lee Radtke, Lake Zurich, IL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/161,240

(22) Filed: May 31, 2002

Related U.S. Application Data
(63) Continuation-in-part of application No. 09/290,056, filed on Apr. 12, 1999, now Pat. No. 6,398,132.

(51) Int. Cl. B05B 15/00

(52) U.S. Cl. 239/289; 239/333; 239/152; 222/383.1; 222/525; 222/175

(57) ABSTRACT

A portable spray misting device including an internally hollowed body capable of holding a volume of fluid to be dispensed. The body includes a substantially bottom facing surface and a contoured upper body terminating in an upwardly extending and interiorly open neck which defines a first port having a first diameter. A spray applicating head for issuing a mist spray of said fluid is secured to said open neck by means of an integrally formed collar and a portable fan unit including a plurality of rotatable blades may be secured atop the spray applicating head. An interiorly open and annular rim extends from a specified location of the bottom facing surface and defines a second port with a diameter greater than the first diameter of the first port. A cap is provided for securing in a fluid-tight manner over the annular rim of the second collar and so as to provide a device which permits a user to more quickly refill a fluid reservoir within the body interior and to facilitate reception of larger sized ice cubes and the like.

### CROSS REFERENCE TO RELATED APPLICATIONS

The present application is a continuation in part of U.S. application Ser. No. 09/290,056, filed Apr. 12, 1999, and titled Cooling Device Using Fan-Driven Misting with Large Fill and Drinking Port

### BACKGROUND OF THE INVENTION

1. Field of the Invention

The present invention relates generally to portable spray misting devices, both with and without fan assisting cooling and dispersion assemblies, and, more particularly, to a such a cooling device using fan-driven misting with a large fill and drinking port located on a bottom facing surface.

2. Description of the Prior Art

It is well known in the art that a fine mist or spray of a liquid can cool the surrounding air by evaporation and that this principle has been used in personal cooling devices. Cooling occurs when mist droplets impinge upon a target and are evaporated into the surrounding air. Additional cooling takes place if the liquid itself is very cold relative to the surrounding air and if an air stream blows on the user so as to accelerate the evaporation of water from the skin and clothing.

In practice, mists are generated inexpensively with plastic trigger or push button actuated piston pumps when the liquid contained with the dispensing body is at or near an atmospheric pressure and with aerosol valve/actuator sets when the liquid reservoir is above atmospheric pressure. Plastic piston pump misters are commonly and inexpensively available which employ a screw collar for attaching to the top of a conventional fluid-carrying bottle with a threaded neck.

However, the shortcoming of conventional bottle neck designs is that they are of standard dimension to accommodate the screw cap of the misting device and therefore do not easily permit the insertion into the container of ice cubes as one would want to do if the liquid in the reservoir needs to be cooled. It is also standard practice to have the spray mister removed from the fluid reservoir to permit repeated refilling.

As a seal or gasket is often utilized between the annular collar of the mist sprayer attachment and the open neck of the receptacle, repeated loosening and tightening tends to result in early failure of the seal. Furthermore, if the user desires to repeatedly drink the water out of the reservoir or to empty it, the relatively small sized opening of the neck results in slow emptying and the user further cannot continue misting while refilling the reservoir.

The provision of spray bottles incorporating a bottom fill port is also known in the art. An example of this is the Aries ICE water spray fan and which includes the features of a substantially three dimensional and circular shaped body terminating in an upwardly facing and narrowed neck and upon which is screw fitted a spray head portion. A portable misting fan is secured upon the spray head and the device further includes a bottom directed, enlarged and downwardly extending secondary fill port; this further being threadably engaged to annular projecting threads associated with and extending from the bottom of the circular shaped body.

Another example of the prior art is illustrated in Chu U.S. Pat. No. 5,740,948 and which discloses a multi-functional compound integrated bottle, a spray device and a driver. The integrated bottle body further includes a first bottle body at the bottom and a second bottle body at the top, and such as may further be connected together in annular screw fashion. Chu further discloses that the bottom body portion includes an opening (112) sealed by a lid cover (113).

### SUMMARY OF THE PRESENT INVENTION

The present invention is a portable spray misting device which is an improvement over prior art spray misters. The device includes an internally hollowed body capable of holding a volume of a fluid to be dispensed. The body has a substantially flattened base, a contoured upper body, and terminates in an upwardly extending and interiorly open neck which defines a first port having a first diameter.

A spray applicating head is provided for issuing a mist spray of fluid and, according to one preferred embodiment, is secured atop the open neck of the body by a threaded collar. In additional preferred embodiments, the collar is permanently secured to the open neck by adhesives, heat staking, welding or securably fashioning a split collar around the open neck so as to sandwich therebetween a downwardly facing flange portion of the spray head.

An interiorly open and annular rim extends from a specified bottom facing location of the body and defines a second port having a second diameter greater than the first diameter of the first port. A cap is provided and is capable of being resecured over the annular rim so as to provide access to the reservoir defined within the body interior at a second location, the second port defined within being of sufficient diameter to permit the insertion of ice cubes and further operable to permit the user to quickly empty or refill the reservoir.

The cap preferably also includes, in one preferred embodiment, a spout and valve assembly which is actuable between a first closed position and a second open position and permits the user access to the fluid interior through the second port and without the need to disengage the cap from the annular rim. The cap in this variant may further be recess mounted relative to the bottom surface of the body and so that, particularly in its closed position, the body may be supported upon a level surface.

According to a further preferred embodiment, the cap includes a screw threaded attachment secured to the second port in projecting fashion from the bottom facing surface. In this embodiment, the size and dimension of the cap is sufficient that the body is adequately balanced and supported by virtue of the dimensions of the cap alone projecting from the bottom facing surface of the body.

A portable fan unit includes a plurality of rotatable blades and is capable of being releasably secured atop the spray misting head so as to direct the spray mist into a path of the rotating blades so as to further cool and distribute the spray. The fan unit further includes an elongated pedestal support portion rotatably secured to the body of the fan unit and which is rotatable from a first hidden position to a second engaged position so that, upon detachment of the fan unit, it is capable of setting upon a table top surface.

Additional features of the present device may include an insulating jacket applied around the internally hollowed body for maintaining the temperature of the fluid contents, a lanyard loop portion secured to the body, a belt clip extending from the body, and a decorative covering material applied over the body, such as a stuffed plush toy animal shape or the like. The covering material over the sprayer may also be provided as a molded vinyl piece.

### BRIEF DESCRIPTION OF THE DRAWINGS

Reference will now be made to the attached drawings, when read in combination with the following specification, wherein like reference numerals refer to like parts throughout the several views, and in which:

FIG. 1 is view of a portable spray misting device, in partial cutaway, according to a first preferred embodiment of the present invention and which incorporates a bottom recessed screw attachment associated with second fill port;

FIG. 2 is a front view of the portable spray misting device shown in FIG. 1 and further illustrating the second port with screw cap which, upon removal, permits access to the fluid receptacle according to the present invention;

FIG. 3 is a rear view of a portable spray misting device and further showing an insulating jacket applied thereto as well as lanyard loop according to the present invention;

FIG. 4 is an enlarged bottom partial view in partial cutaway and perspective, and which illustrates the recessed nature of the bottom fill port screw cap according to the embodiment of FIGS. 1 and 2;

FIG. 5 is a side view of a portable spray misting device according to a further preferred embodiment of the present invention and in which a spout and valve assembly is incorporated into the second port in a recessed fashion;

FIG. 6A is a perspective view of the spout and valve assembly also shown in FIG. 5;

FIG. 6B is a side view of the spout and valve and further illustrating the provision of an attachment ring for securing about an annular projecting portion associated with the bottom secondary fill port;

FIG. 6C is an extended view of the spout and valve with attachment ring also shown in FIG. 6B;

FIG. 7A illustrates a friction fit arrangement established between the cap and associated annular rim of the second port according to a further variant of the present invention;

FIG. 7B illustrates an alternate threaded engagement variation established between the cap and the associated annular rim of the second port according to a still further variant of the present invention;

FIGS. 8A-8C are respective top, side and front views of a belt clip which extend from the internally hollowed body according to the present invention;

FIGS. 9a and 9b are respective side cutaway sectional views of open threaded necks of the internally hollowed body and illustrate both screw mating of an annular collar integrally formed with the spray misting head and permanent adhesive securing of the collar to the open neck according to the present invention;

FIGS. 10a and 10b are respective top and side cutaway views of a collar of a spray misting head permanently secured to an open neck by ultrasonic welding;

FIGS. 11a and 11b are respective top and side cutaway views of a collar of a spray misting head permanently secured to an open neck by heat staking the collar to the neck;

FIGS. 12a-12c are respective top, first side and second side views of a split collar arrangement assembleable around the open neck and sandwiching therebetween a downwardly facing flange portion of the spray misting head according to the present invention;

FIG. 13 is an exploded view of the split collar illustrated in FIGS. 12a-12c and the manner of securing to the open neck to sandwich the spray misting head flange therebetween;

FIG. 13a is a view of the portable spray misting device according to a further preferred variant and which includes a decoratively applied covering;

FIG. 14 is a view of the portable spray misting device, substantially according to the first preferred embodiment, and including a portable fan unit resecurably attachable atop the spray misting head according to the present invention;

FIG. 15 is a view of the portable spray misting device according to a still further preferred embodiment of the present invention and which illustrates the cap associated with the secondary fill port as a screw threaded attachment secured thereto;

FIG. 16 is a front view of the portable spray misting device as shown in FIG. 15 and with the cap in exploded fashion so as to reveal downwardly and annularly arrayed screw threads associated with the secondary port;

FIG. 17 is a top view of the portable fan unit, and such as is shown in FIGS. 14-16, which is capable of being disengaged from the spray misting unit;

FIG. 18 is a side cutaway view of the portable fan unit as shown in FIG. 17 and illustrating in phantom the elongate pedestal support portion;

FIG. 19 is a bottom view of the fan unit shown in FIGS. 17 and 18 and further illustrating in extra detail the elongate pedestal support portion; and

FIG. 20 is a side view in solid which is largely identical to that shown in FIG. 18 and illustrating the pedestal support portion of the fan unit in a downwardly rotated and engaged position.

### DETAILED DESCRIPTION OF THE PREFERRED EMBODIMENTS

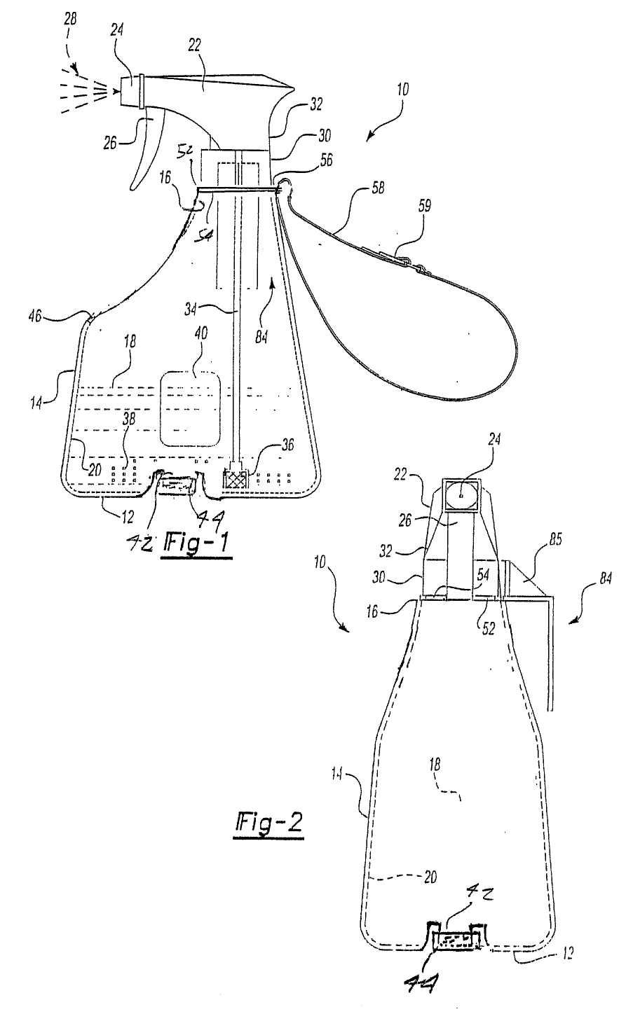

Referring now to FIGS. 1 and 2, a portable spray misting device is illustrated at 10 according to a first preferred embodiment of the present invention. In particular, the present invention incorporates a secondary and bottom directed fill port which is a non-obvious improvement over prior art secondary fill port designs.

The spray misting device 10 includes an internally hollowed body which includes a substantially flattened base 12, a contoured upper body 14 and an upwardly extending and open neck 16 which defines a first port having a first established diameter. The misting device body is preferably constructed of a plasticized material, but may also be glass or any other suitable material.

The view of the internally hollowed body in FIG. 1 is partially cutaway an illustrates the internal fluid carrying reservoir formed within the body and which is defined by fluid level 18 and a surrounding wall thickness 20. A spray applicating head is shown at 22 and includes a nozzle 24 which is operable through a squeeze trigger 26 to issue a spray mist 28.

An annular collar 30 is integrally formed with a base 32 of the spray head 22 and further includes an elongate and downwardly extending stem 34. The stem 34 terminates in an enlarged end containing a filtration portion 36, such portion being particularly suited for filtering out precipitated minerals (see within fluid level 18 at 38) resulting from melted ice cubes (at 40) which are capable of being deposited within the body interior as will be subsequently described.

Referring again to FIGS. 1 and 2, a second port 42 is defined within a bottom facing flattened base 12 and has a second diameter which is greater than the first diameter of the first port (or open neck 16). A cap 44 is provided and which is capable of being resecurably attached over the annular rim 42 defining the second port in secure and fluid sealing fashion. As is also illustrated, the cap 44 is disposed either in substantially flush manner with the surface of the flattened base 12 or, alternatively, the body of the spray bottle can be configured so that the cap 44, when mounted, is recessed inwardly therefrom.

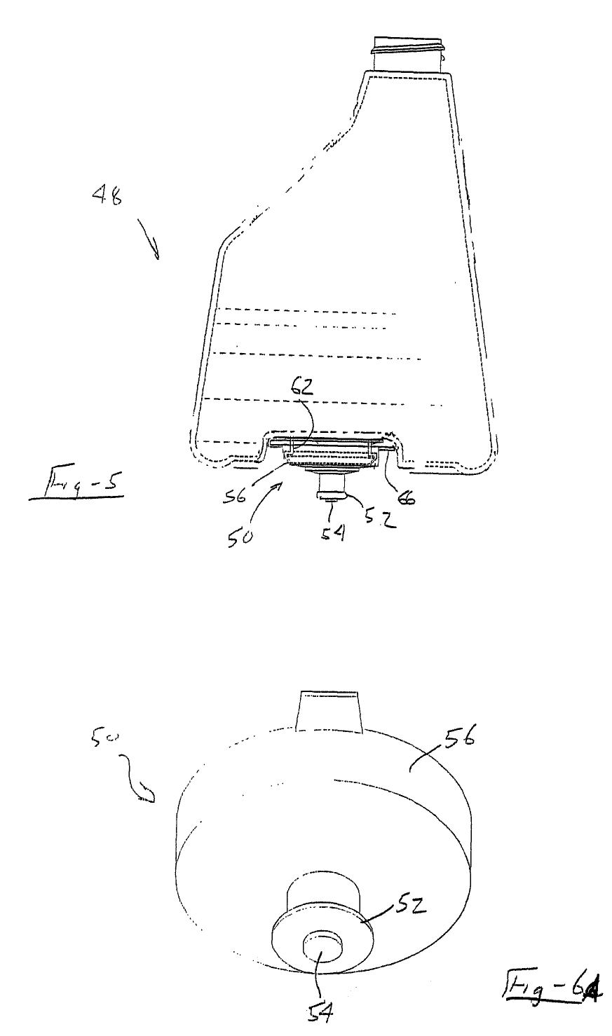

As is further shown in FIG. 4, the cap 44 includes knurled edges 46 which facilitates permitting it to be threadably engaged and disengaged from the exteriorly threaded and annular configuration of the second port 42. The diameter of the second port defined by the annular rim 42 is again some value greater than the first port defined by the open neck of the bottle or internally hollowed body and, according to one variant, is preferably at least 1.25 inches or greater in dimension for the purpose of easy emptying and refilling and to permit larger solid objects, such as ice cubes 40, to be inserted within the hollowed interior of the body.

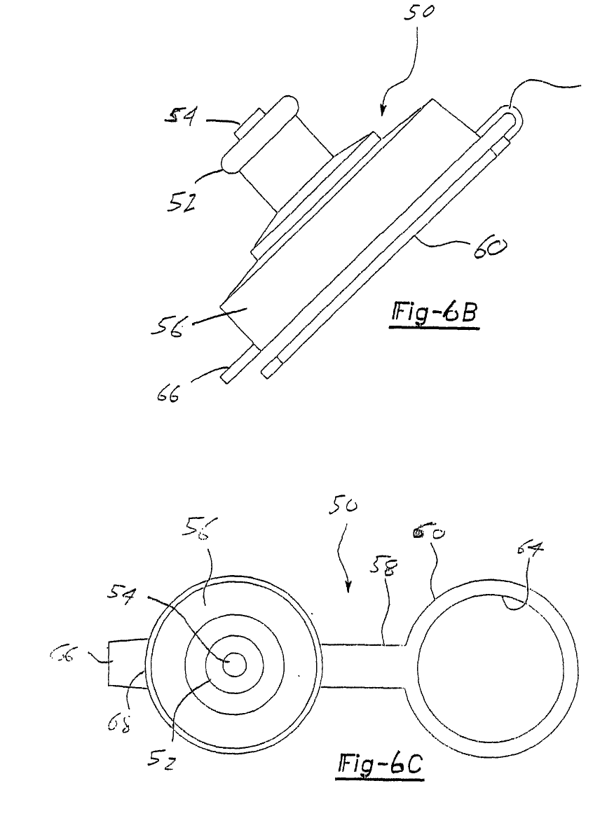

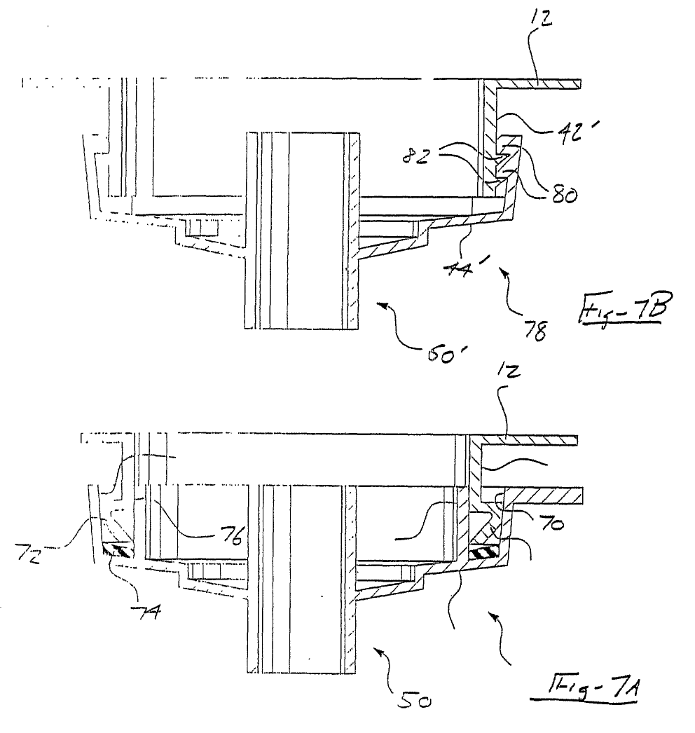

Referring to FIG. 5, a further preferred variant of the portable spray misting device is shown at 48 (in side cutaway and with the spray applicating head 22 removed). As also shown again in FIGS. 6A-6C, a spout and valve assembly 50 is provided in use covering the second port. The spout and valve assembly 50 includes an upwardly and downwardly centrally hollowed and actuable ring 52 which is configured so that, when pulled in an outward direction, reveals an open annular channel established with a central button 54 to permit fluid from the container to be emptied in a stream. As is also best illustrated in FIG. 5, the central ring 52 can reside substantially flush or slightly recessed with respect to the bottom surface 12 of the body and, when actuated outwardly, can extend a given distance.

The spout and valve assembly further includes a main substantially circular shaped body 56, to which is secured an attachment ring assembly including a connecting strap 58 extending from an outer annular location of the body 56. The connecting strap 58 extends to an opposite ring 60. The purpose of the opposite ring 60 of the attachment ring assembly is to secure around an annular rim 62 (see FIG. 5), the ring 60 further including an inwardly facing and annular edge surface 64 suited to encircle the annular rim 62 defining the bottom facing and second fill port and to provide a retaining means to the assembly when the spout is disengaged from the second port. Additional features include a gripping tab 66 extending from a further opposite location 68 of the main circular shaped body 56.

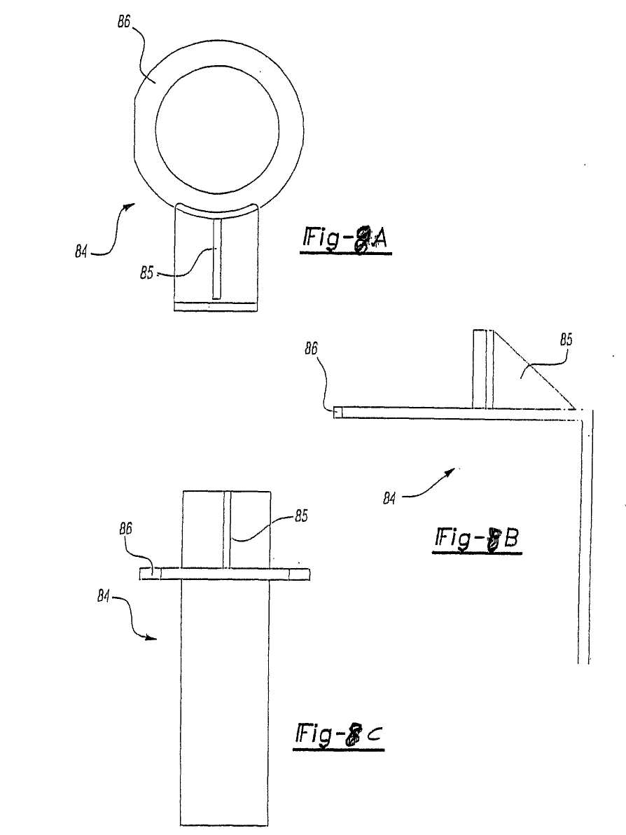

Referring to FIG. 7A, a sectional side view is illustrated in cutaway of the engagement between the annular rim 42 of the second port and the releasably affixable cap, such as is substantially shown by the spout and valve assembly 50 according to a primary preferred embodiment. The cap includes an inwardly facing surface annular surface 70 which defines an interference or friction fit with a contoured and outwardly facing surface 72 of the annular rim 42. A circular gasket 74 is also arrayed between the annular surfaces 70 and 72 and the cap 44 may further include a coaxially spaced inner annular wall 76 for pinching the contoured surface 72 of the rim 42 therebetween.

Referring to FIG. 7B, a further variant 78 of the engagement between an annular rim 42′ and a releasably affixable cap 44′ is illustrated and includes a plurality of inwardly facing screw threads 80 which extend from the annular cap 44′ and which rotatably interengage with exterior threads 82 extending from the annular rim 42′. A central through aperture for a spout and valve assembly 60′ is likewise illustrated.

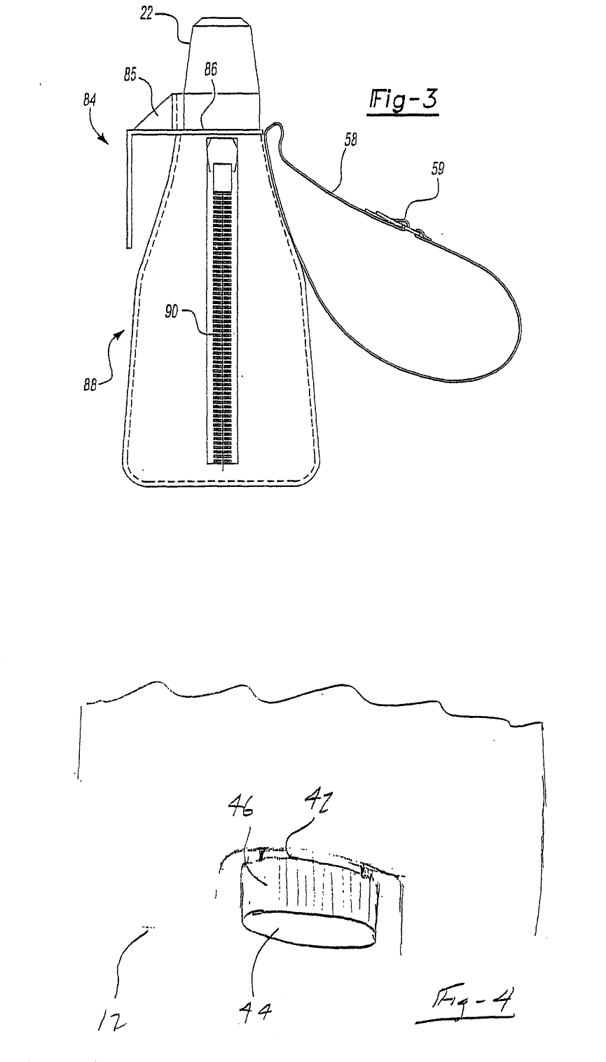

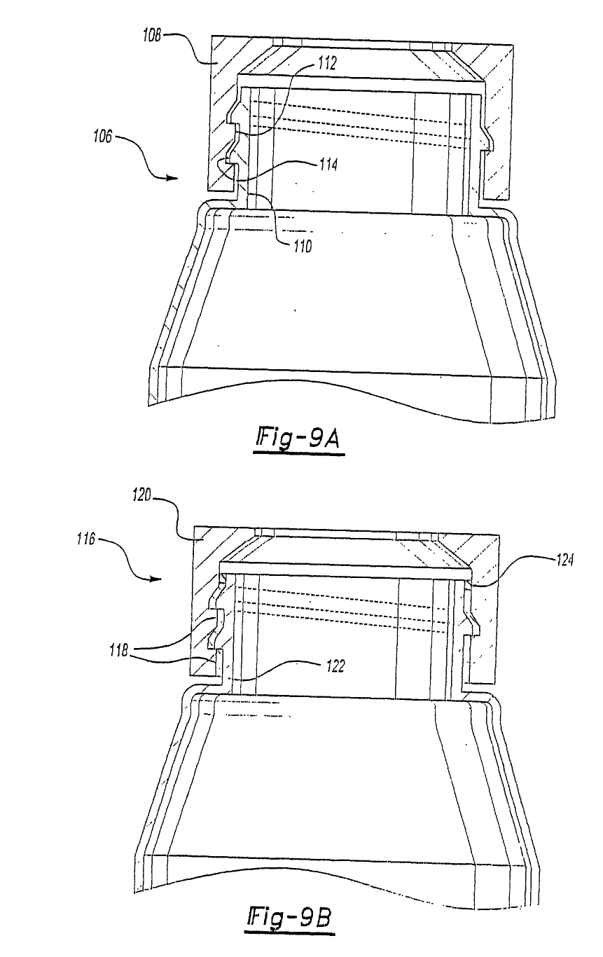

Referring again to FIGS. 1-3 and also to FIGS. 8A-8C, a belt clip 84 is illustrated which includes a substantially angular body with a reinforcing bracket portion 85 and a circular mounting portion 86 capable of being secured to the open neck 16 bottle. Referring to FIG. 3, an insulating jacket 88 is provided which is constructed of an appropriate insulating material which is also flexible to a degree and which is configured for insertingly receiving the body of the spray misting device 10. A zipper 90 is provided running substantially vertically along a rear side of the device 10 and for resealably closing the insulating jacket 88 around the device body, however it is understood that other alternative sealing means may also be employed such as Velcro attachments, loop fasteners and the like. Although not shown, it is also understood that the configuration of the insulating jacket 88 is such that access to the bottom (second) fill port is maintained, such as further by sectioning a hole into the jacket 88 corresponding to the location of the secondary port.

As is again shown in FIG. 1, the configuration of the second port is such that ice cubes 40 may be inserted within the internally hollowed body. This is of particular advantage since the diameter of the first port (or open neck 16) is typically such as to prevent passage of normal sized ice cubes and further since that repeated opening and closing of the annular collar 80 will over time cause damage to or failure of the gasket or seal (again at 74 in FIGS. 7A and 7B).

Referring now to FIG. 9a, a side view in cutaway is illustrated of a first further preferred variant 106 for securing an annular collar 108 to an open neck 110 of a spray misting bottle. Specifically, FIG. 9a illustrates a conventional screw thread arrangement for securing the collar 108 and which includes internal threads 112 formed within the annular collar 108 which rotatably interengage with corresponding external threads 114 formed in the open neck.

Referring now to FIG. 9b, an alternate variation is further illustrated at 116 and includes an adhesive 118 applied to mating surfaces of an annular collar 120 and open neck 122 for the purpose of securably and permanently fixing the annular collar 120 atop the spray misting bottle. As was previously stated, a purpose for permanently affixing the collar and spray applicating head atop the misting bottle is to provide the ability to continuously utilize the misting feature and also to protect against wear and tear of a seal or gasket 124 existing between the annular collar 120 and open neck 122.

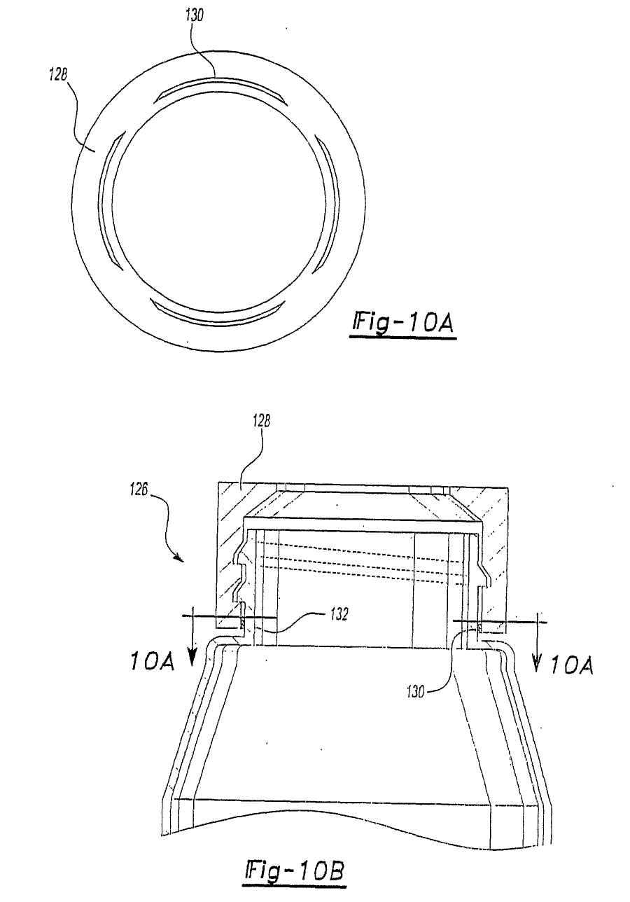

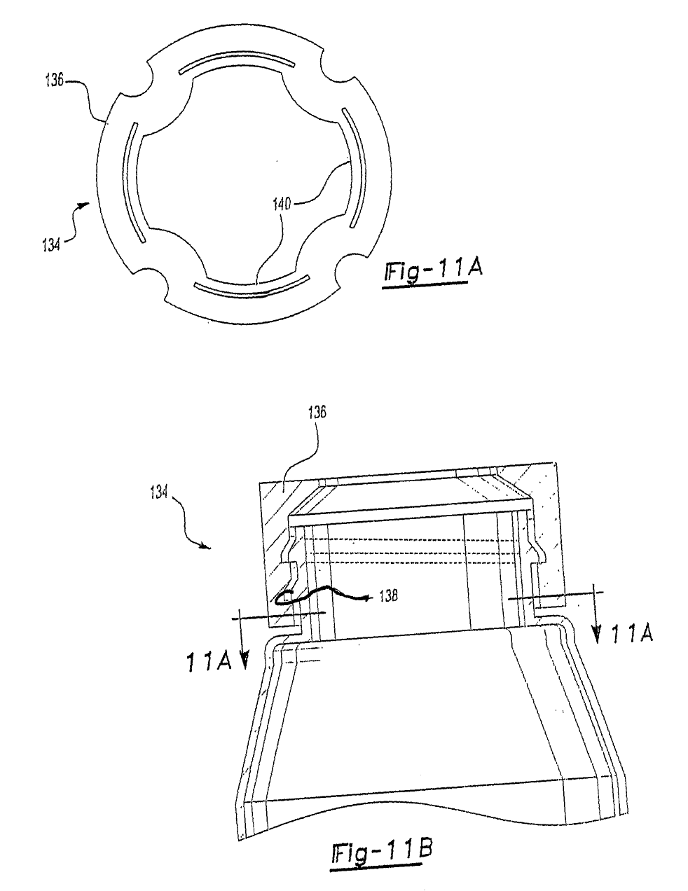

Referring now to FIGS. 10a and 10b, a further variation 126 of attaching an annular collar 128 is illustrated and includes annular arrayed and ultrasonic welds 130 applied between the collar 128 and open neck 132 for the purpose of permanently affixing the collar 128 to the misting bottle. The ultrasonic welds function to cause friction between two pieces of plastic rubbing together to generate heat, melting one or both of the opposing surfaces. The melted plastic bonds the two parts when the melted interface cools. The welds 130 may be applied in any conventional fashion by tools known in the art and are preferably drawn from a heated and viscous polymer material which will bond integrally with the preferable polymer construction of the annular collar 128.

Referring to FIGS. 11a and 11b, a yet further variation 134 for securing an annular collar 136 atop an open neck 138 of a spray bottle in secure and permanent fashion is provided by a heat staking process which involves applying heat to the outside of the annular collar 136 (see also annular surfaces 140) which in turn causes the collar to bond intimately with the corresponding outwardly facing annular surfaces 138 of the open neck in a process somewhat similar to the application of an external welding material such as in FIGS. 10a and 10b.

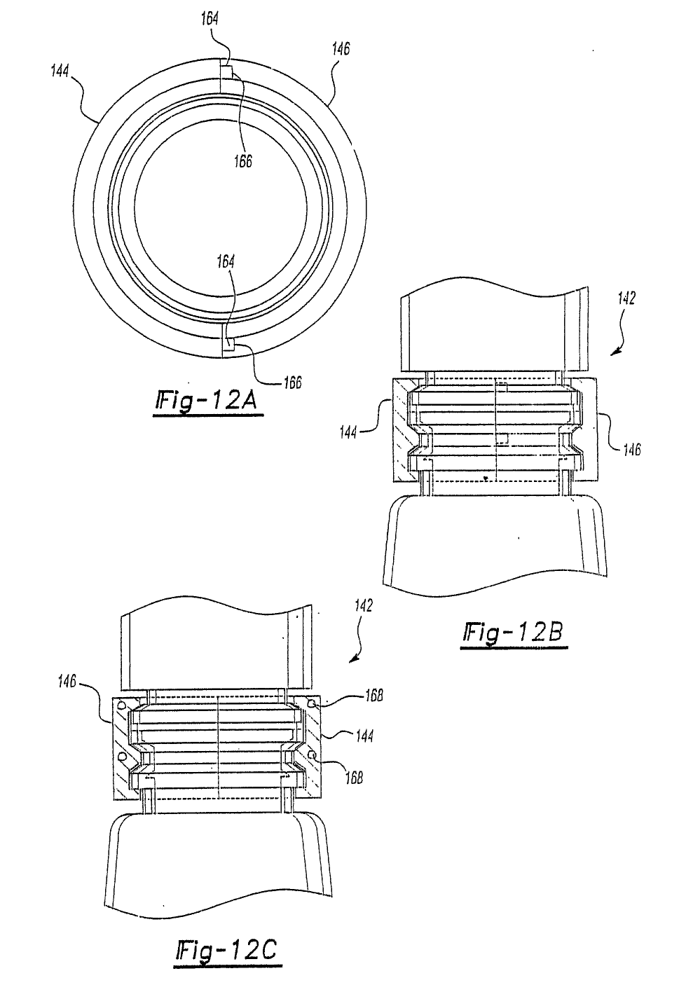

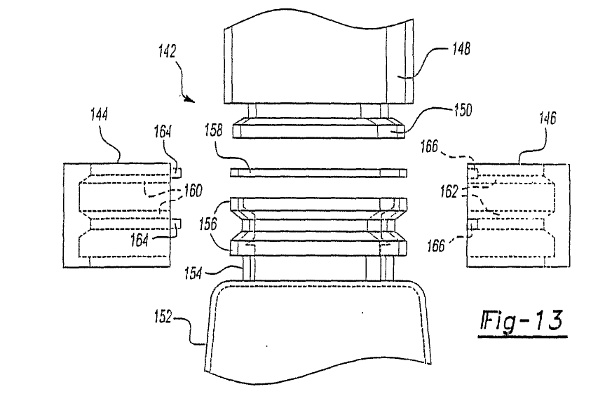

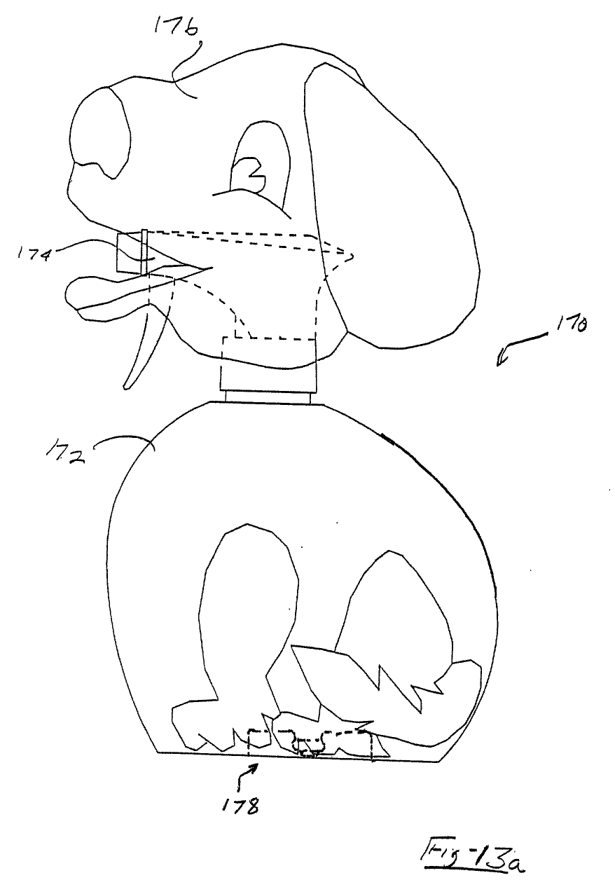

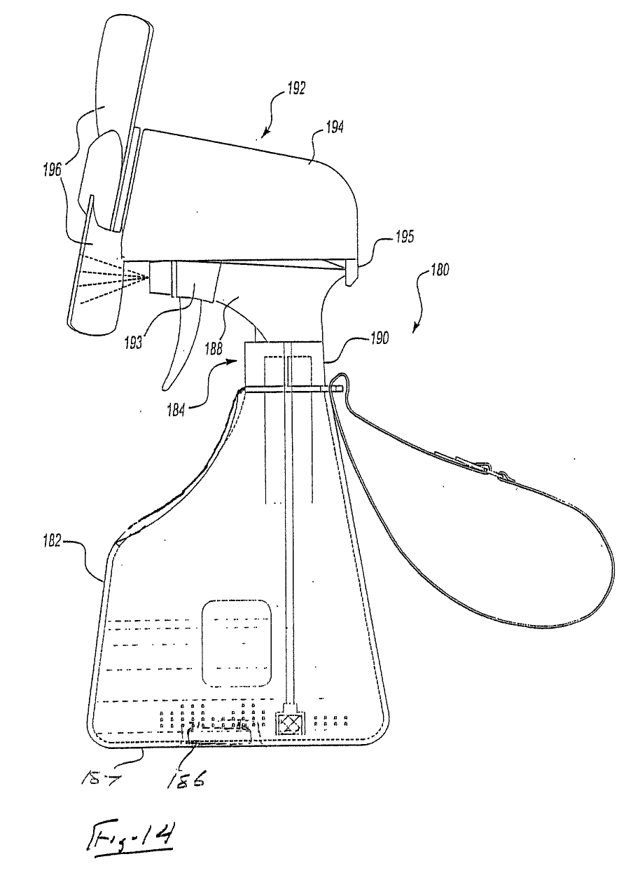

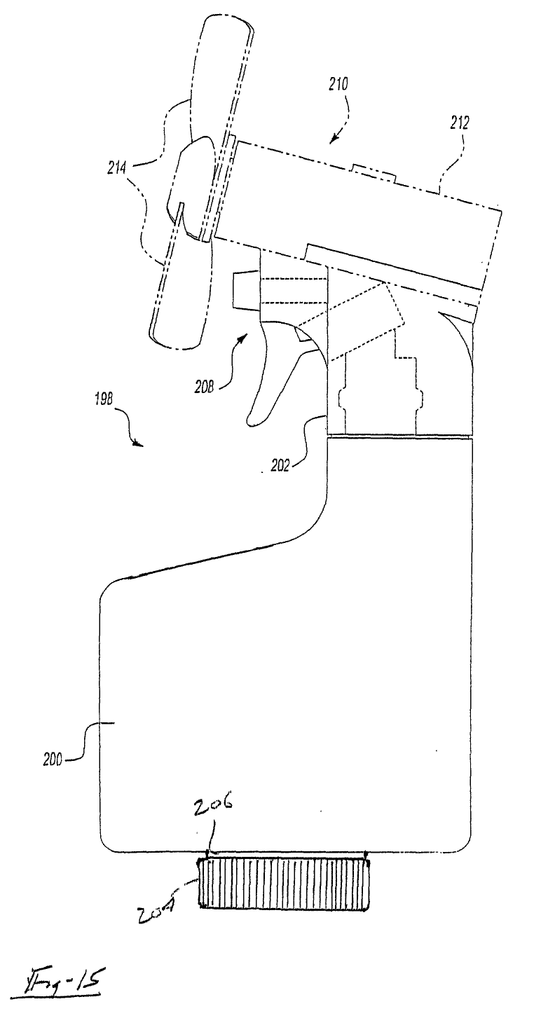

Referring further to FIGS. 12a-12c and also to FIG. 13, a still further variation 142 is illustrated of an annular collar attachment means for permanently securing a spray applicating head atop a misting bottle. Specifically, the annular collar is provided in an assembleable and clamping arrangement and includes a first half 144 and a second half 146. The halves 144 and 146 are to be secured together by applied adhesives or ultrasonic welding as previously described. As is also shown in FIG. 13, a spray applicating head includes a lower body 148 and terminates in a downwardly facing flange portion 150. An internally hollowed body 152 includes an open neck 154 upon which are configured outwardly flared portions 156. A gasket or seal 158 is also illustrated in the exploded view of FIG. 13 and is sandwiched between the downwardly facing flange portion 150 of the spray applicating head 148 and the upwardly facing surface of the open neck 154 upon application of the first and second halves 144 and 146 annular collar.

The first half 144 includes an inner annular contour, as illustrated by phantom lines 160, and which are matched by corresponding phantom lines 162 for providing a like inner annular contour in the second half 146 as best shown in FIG. 13. Alignment pins 164 extending from the first half 144 engage within corresponding recesses 166 in the second half 146 to secure the collar in mating fashion about the open neck 154 and sandwiching the downwardly facing flange 150. Referring once again to FIG. 12c, the first and second halves may also be assembled together through the use of pins 168 which recess within like configured apertures in the collar halves.

Referring now to FIG. 13a, a further embodiment 170 is disclosed of a spray misting device of the present invention and includes a decorative covering material 172 applied over the spray misting device. The device includes in one preferred variant an internally hollowed body (substantially hidden from view), a spray applicating head 174 camouflaged within a decorative head 176 of similar material to that of the covering material 172 and affixed over the spray applicating head 174, and a second bottom fill port assembly 178 which is identical in construction to that previously described. The decorative covering material may consist of any animal design or the like and is intended to be an attractive addition to the portable spray misting device of the invention. Alternatively, the bottle itself may be constructed as the decorative design without departing from the scope of the invention.

Referring now to FIG. 14, a portable spray misting device is illustrated at 180 according to a yet further preferred embodiment of the present invention. The device 180 again includes an internally hollowed misting bottle 182 with first port 184 and second larger fill port 186 and also with a spray applicating head 188 which is secured by an annular collar 190 to the first port 184. The device 180 differs in that it also discloses a portable fan unit 192 having a body 194 and a plurality of blades 196 which are rotatably connected to the body 194 of the unit. The fan unit 192 is releasably secured atop the spray applicating head 193 such as through the use of downwardly extending engaging tabs (forward at 193 and rearward at 195) which are contoured for gripping corresponding locations of the spray applicating head. Upon issuance of a mist spray directed into a path of the rotating fan blades 196, the mist contacts the blades and is cooled and distributed further, such as through evaporation into the surrounding air. The construction and operation of the spray misting device 180 is further substantially identical to that disclosed in the earlier preferred embodiments, particularly FIGS. 1-6, such that a repetitive explanation is unnecessary.

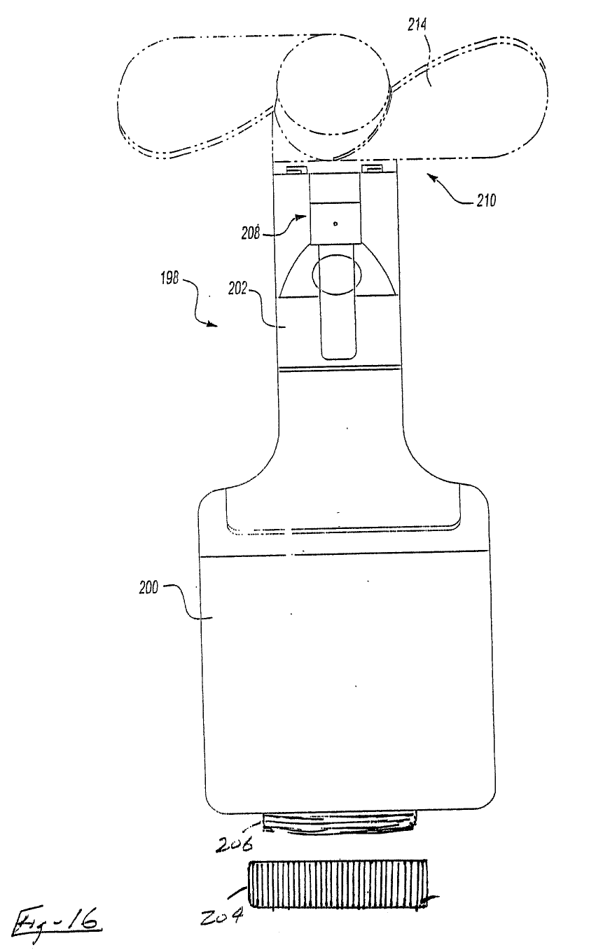

Referring now to FIGS. 15 and 16, side and front views are shown respectively of a portable spray misting device 198 according to a further preferred variant. The misting device 198 is similar in most regards to that illustrated at 180 in FIG. 14 in that it includes an internally hollowed body 200 with an upper neck 202 defining a first port and a cap 204 affixable in a fashion previously described over a configured annular rim 206 to define a second port. The embodiment of FIGS. 15 and 16 include a spray applicating head assembly 208 which is substantially integrally formed with the upwardly extending upper neck 202.

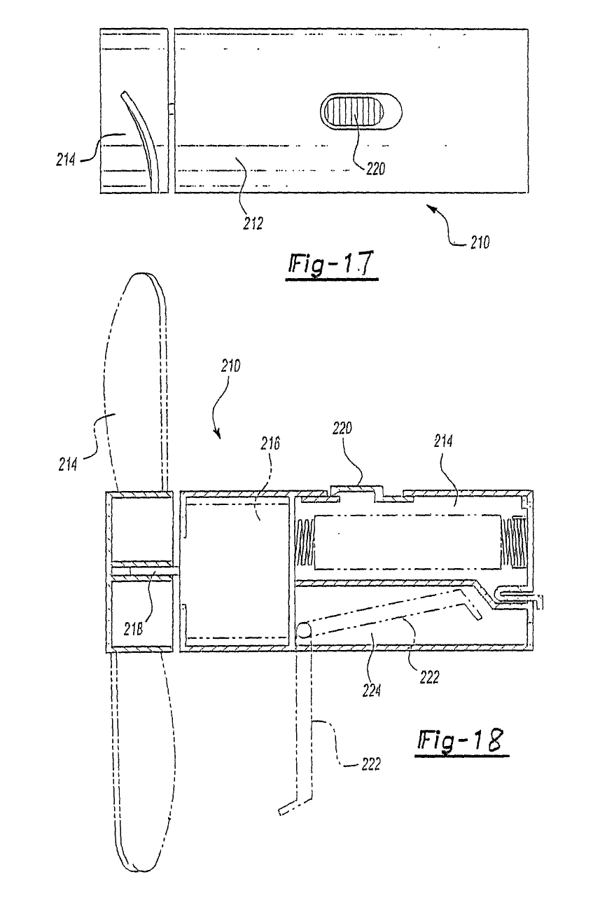

A portable fan unit 210 having a body 212 and rotatable blades 214 secured to the body 212 is illustrated secured atop the spray applicating head assembly 208. The fan unit 210 is capable of being secured by gripping tabs such as was previously described with reference to the embodiment of FIG. 14 or may be secured by other means such a sliding track arrangement existing between an underside of the fan unit body and the corresponding mounting surface extending from the top of the spray applicating head. As is best illustrated with reference to FIGS. 17-20 in succession, the fan unit 210 is dismountable from atop the spray applicating head and is capable of being separately utilized.

Specifically, referring to FIG. 18, a cutaway view is shown of the fan unit 210 which includes one or more batteries 214 contained within the unit body 212 and a small electric motor 216 which is operatively powered by the battery to drive the fan blades 214 via a drive shaft 218. Referring also to FIG. 17 an on/off switch 220 is provided for selectively activating and deactivating the fan unit 210.

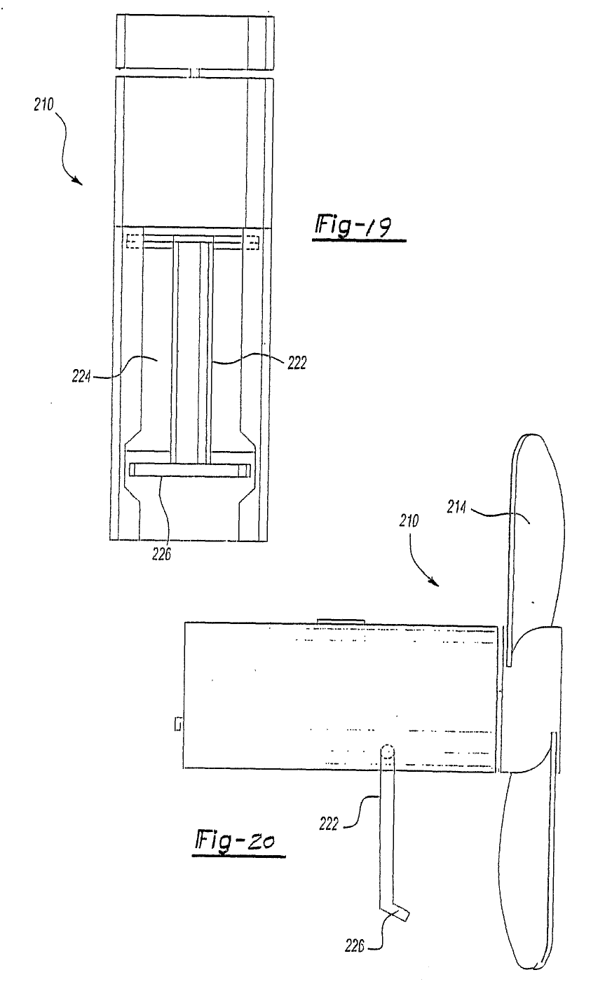

Referring again to FIG. 18, and also to FIGS. 19 and 20, an elongate pedestal support portion 222 is provided which is recessed in a first folded position (see phantom lines in FIG. 19) within a compartment 224 of the fan unit body. The pedestal support portion 222 includes (as best illustrated from the detached and underside view of FIG. 19) a laterally extending foot portion 226 which permits the pedestal support portion 222, upon it being rotated from the first hidden position to a second engaged position as also shown again in FIGS. 18 and 20, to engage a table top surface (not shown) and to support the fan unit in an upwardly angled and operative condition apart from its use with the spray misting device.

Having described my invention, it will become apparent that it discloses a novel and useful cooling device using fan-driven misting with a large fill or drinking port which is a non-obvious improvement over prior art devices. Having described my invention, additional preferred embodiments will become apparent to those skilled in the art to which it pertains without deviating from the scope of the appended claims.

I claim:

1. A portable spray misting device comprising:
an internally hollowed body capable of holding a volume of a fluid to be dispensed, said body having a base and a contoured body, said body terminating in an upwardly extending and interiorly open neck which defines a first port having a first diameter;
a spray applicating head for issuing a mist spray of said fluid and securing means for attaching said applicating head to said open neck;
an interiorly open and annular rim associated with a bottom facing location of said contoured body and defining a second port, said second port having a second diameter which is greater than said first diameter; and
a cap and resecuring means for securing said cap in a fluid-tight manner over said second port.

2. The portable spray misting device as described in claim 1, said cap further comprising a spout and valve assembly actuable between a first closed position and a second open position.

3. The portable spray misting device as described in claim 1, further comprising a retaining strap extending between said cap and said body.

4. The portable spray misting device as described in claim 3, said retaining strap further comprising an attachment ring capable of being secured about said second port of said body.

5. The portable spray misting device as described in claim 1, said resecuring means further comprising an inwardly facing surface of said cap defining an interference fit with a corresponding outwardly facing surface of said annular rim of said second port.

6. The portable spray misting device as described in claim 1, said spray applicating head further comprising an annular collar integrally formed to said spray head, an elongate stem extending from said spray head, through a central opening in said collar, and downwardly into said internally hollowed body.

7. The portable spray misting device as described in claim 6, said securing means further comprising internal threads formed within said annular collar, said collar rotatably interengaging with corresponding external threads formed in said open neck.

8. The portable spray misting device as described in claim 6, said securing means further comprising an adhesive applied between said annular collar and said open neck to permanently secure said spray applicating head to said body.

9. The portable spray misting device as described in claim 6, said annular collar being constructed of a polymer based material, said securing means further comprising heat staking said annular collar to said open neck.

10. The portable spray misting device as described in claim 6, said securing means further comprising ultrasonic welds applied between said annular collar and said open neck.

11. The portable spray misting device as described in claim 1, said securing means further comprising an annular collar defining a first half and a second half, said halves being assembled around said open neck so as to sandwich an annular and downwardly facing flange portion of said spray head.

12. The portable spray misting device as described in claim 1, further comprising a portable fan unit including a plurality of blades rotatably connected to said unit, said fan unit being releasably secured atop said spray applicating head so that said mist spray is directed into a path of said rotating blades and, upon contact with said blades, is cooled and distributed.

13. The portable spray misting device as described in claim 12, said fan unit further comprising an elongate pedestal support portion rotatably secured to a body of said fan unit, said support portion being rotated from a first hidden position to a second engaged position upon releasably securing said fan unit from spray applicating head and for supporting said fan unit upon a table top surface.

14. The portable spray misting device as described in claim 6, further comprising a filtration element formed at a distal end of said downwardly extending stem for filtering out at least one of contaminants and precipitated minerals resulting from melted ice cubes deposited through said second port and into said internally hollowed body.

15. The portable spray misting device as described in claim 1, further comprising an insulating jacket and means for applying said jacket around said internally hollowed body.

16. The portable spray misting device as described in claim 1, further comprising a lanyard loop portion secured to said body.

17. The portable spray misting device as described in claim 1, further comprising a belt clip extending from said body.

18. The portable spray misting device as described in claim 1, further comprising a decorative covering material applied over said body.

19. The portable spray misting device as described in claim 4, said spout and valve assembly being recessed within said bottom facing location of said body.

20. The portable spray misting device as described in claim 1, said cap further comprising a screw threaded attachment secured to said second port.

21. The portable spray misting device as described in claim 20, said cap projecting a selected distance from a substantially level surface defining said bottom facing location of said body.

22. A portable spray misting device comprising:
an internally hollowed body capable of holding a volume of a fluid to be dispensed, said body having a base and a contoured body, said body terminating in an upwardly extending and interiorly open neck which defines a first port having a first diameter;
a spray applicating head for issuing a mist spray of said fluid and securing means for attaching said applicating head to said open neck;
a portable fan unit including a plurality of blades rotatably connected to said unit, said fan unit being secured atop said spray applicating head so that said mist spray is directed into a path of said rotating blades and, upon contact with said blades, is cooled and distributed;
an interiorly open and annular rim recessed within a bottom facing surface of said contoured body and defining a second port, said second port having a second diameter which is greater than said first diameter; and
a cap and resecuring means for securing said cap in a fluid-tight manner over said second port, said cap further comprising a spout and valve assembly recessed within said bottom facing surface and being actuable between a first closed position and a second open position.

23. A portable spray misting device comprising:
an internally hollowed body capable of holding a volume of a fluid to be dispensed, said body having a base and a contoured body, said body terminating in an upwardly extending and interiorly open neck which defines a first port having a first diameter;
a spray applicating head for issuing a mist spray of said fluid and securing means for attaching said applicating head to said open neck;
a portable fan unit including a plurality of blades rotatably connected to said unit, said fan unit being secured atop said spray applicating head so that said mist spray is directed into a path of said rotating blades and, upon contact with said blades, is cooled and distributed;
an interiorly open and annular rim located at a bottom facing surface of said contoured body and defining a second port, said second port having a second diameter which is greater than said first diameter; and
a cap and resecuring means for securing said cap in a fluid-tight manner over said second port, said cap further comprising a screw threaded attachment secured to said second port and which projects from said bottom facing surface.
